(19) United States
(12) Patent Application Publication
(10) Pub. No.: US 2011/0259655 A1
(43) Pub. Date: Oct. 27, 2011

(54) TRACTOR HAVING HYDRAULIC LIFTING APPARATUS

(76) Inventors: Jung Woong CHOI, Suwon-si (KR); Chul Hwan CHOI, Anyang-si (KR)

(21) Appl. No.: 13/074,354

(22) Filed: Mar. 29, 2011

(30) Foreign Application Priority Data
Apr. 23, 2010 (KR) 10-2010-0038071

(51) Int. Cl. B60K 25/00

(52) U.S. Cl. 180/53.8

(57) ABSTRACT

Provided is a tractor having a hydraulic lifting apparatus, wherein, assuming that a lift of the hydraulic lifting apparatus is P (N), a discharge flow rate of a hydraulic pump is Q (m³/s), a horsepower of an engine is H (N·m/s), an axial distance is L (m), and a total weight of the tractor is W (N), the following Equation is satisfied:

100×H/Q<P<L×W/1.5.

### CROSS-REFERENCE TO RELATED APPLICATION

This application claims priority to Korean Patent Application No. 10-2010-0038071, filed on Apr. 23, 2010, and all the benefits accruing therefrom under 35 U.S.C. §119, the contents of which in its entirety are herein incorporated by reference.

### BACKGROUND

1. Field

This disclosure relates to a tractor, and more particularly, to a hydraulic lifting apparatus which is mounted to a rear part of a tractor for hauling and lifting an operating machine.

2. Description of the Related Art

A tractor is a kind of farm machinery which hauls an operating machine, such as, a shovel, plough, harrow or combine, mounted at the rear thereof to be driven and cultivates fields or rice fields.

FIG. 1 is a diagram schematically illustrating a structure of a general tractor.

Referring to FIG. 1, an engine 20 is mounted on a front wheel 11 side of a tractor 10 according to a related art, and a transmission 30 is connected and mounted to the engine 20 to transmit power to a rear wheel 12 side. In a rear part of the tractor 10, a hydraulic lifting apparatus 50 for mounting various kinds of operating machine 40 for field operations is provided.

The hydraulic lifting apparatus is an apparatus for lifting the operating machine 40 during a movement of the tractor so as to allow the tractor 10 to properly move, and lowering the operating machine 40 during an operation so as to perform ground works. The hydraulic lifting apparatus typically includes a link mechanism for connecting a main body and the operation machine and a hydraulic cylinder for lifting the operating machine via the link mechanism.

Generally, a lift of the hydraulic lifting apparatus 50 of the tractor 10 becomes the standard for selecting the operating machine. In terms of efficiency, if the lift is larger for the same horsepower, larger and various kinds of operating machine can be mounted. In terms of safety, climbing ability or steering performance of a vehicle is enhanced if the operating machine is light. Therefore, it is important to determine the lift of the hydraulic lifting apparatus so as to satisfy the above-mentioned two conditions.

However, according to the related art, there is no standard to determine the lift with respect to a tractor designing, so that there is a problem in that efficiency of the vehicle is degraded and safety is also low, possibly resulting in an overturn or a steering failure state.

### SUMMARY

This disclosure provides a tractor which is prevented from overturning and simultaneously is provided with improved steering performance and a high lift for the same horsepower, thus exhibiting good safety and efficiency.

In one aspect, there is provided a tractor having a hydraulic lifting apparatus, wherein, assuming that a lift of the hydraulic lifting apparatus is P (N), a discharge flow rate of a hydraulic pump is Q (m³/s), a horsepower of an engine is H (N·m/s), an axial distance is L (m), and a total weight of the tractor is W (N), the following relationship is satisfied:

100×H/Q<P<L×W/1.5

Here, the constant 100 has an area unit (m²), and the constant 1.5 has a length unit (m).

In addition, a new tractor design factor is proposed by defining a value obtained by dividing a value obtained by multiplying the axial distance L and the total weight W by the lift P as a safe weight distance ω. Here, the safe weight distance ω may be equal to or greater than 1.5 m. More specifically, the safe weight distance ω may be equal to or greater than 1.5 m and equal to or smaller than 5 m.

In addition, a new tractor design factor is proposed by defining a value obtained by dividing a value obtained by multiplying the discharge flow rate Q and the lift P by the horsepower H as an effective hydraulic efficiency area μ. Here, the effective hydraulic efficiency area μ may be equal to or greater than 100 m².

The disclosed tractor is designed on the basis of the safe weight distance and the effective hydraulic efficiency area which are newly defined. Therefore, safety of the tractor is ensured by minimizing a possibility that the tractor overturns and improving steering performance, and simultaneously efficiency of the hydraulic lifting apparatus is increased.

### BRIEF DESCRIPTION OF THE DRAWINGS

The above and other aspects, features and advantages of the disclosed exemplary embodiments will be more apparent from the following detailed description taken in conjunction with the accompanying drawings in which:

FIG. 1 is a diagram schematically illustrating a structure of a general tractor;

FIG. 2 is a graph showing a relationship between a safe weight distance and an acceptable climbing angle; and

FIG. 3 is a graph showing a relationship between the safe weight distance and an effective rotation radius.

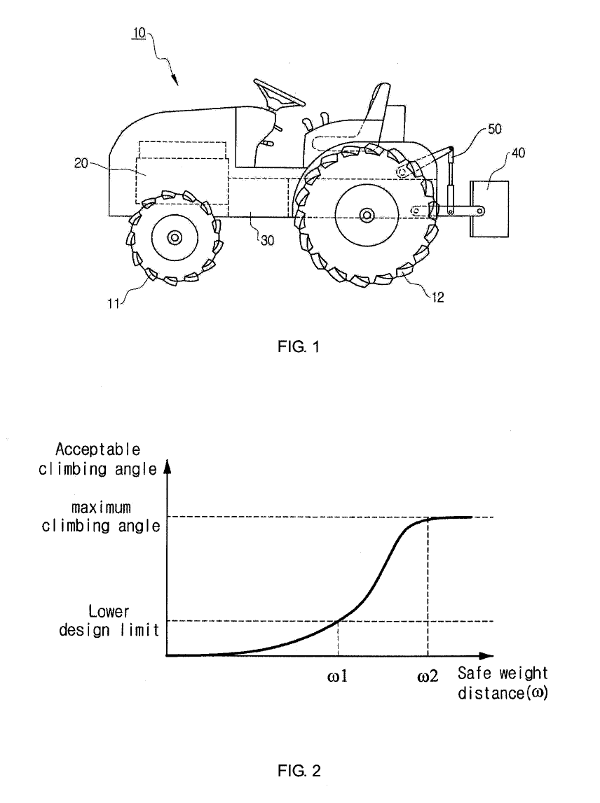

### DETAILED DESCRIPTION

Exemplary embodiments now will be described more fully hereinafter with reference to the accompanying drawings, in which exemplary embodiments are shown. This disclosure may, however, be embodied in many different forms and should not be construed as limited to the exemplary embodiments set forth therein. Rather, these exemplary embodiments are provided so that this disclosure will be thorough and complete, and will fully convey the scope of this disclosure to those skilled in the art. In the description, details of well-known features and techniques may be omitted to avoid unnecessarily obscuring the presented embodiments.

The terminology used herein is for the purpose of describing particular embodiments only and is not intended to be limiting of this disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

In the drawings, like reference numerals in the drawings denote like elements. The shape, size and regions, and the like, of the drawing may be exaggerated for clarity.

Hereinafter, a tractor having a hydraulic lifting apparatus according to an embodiment will be described in detail.

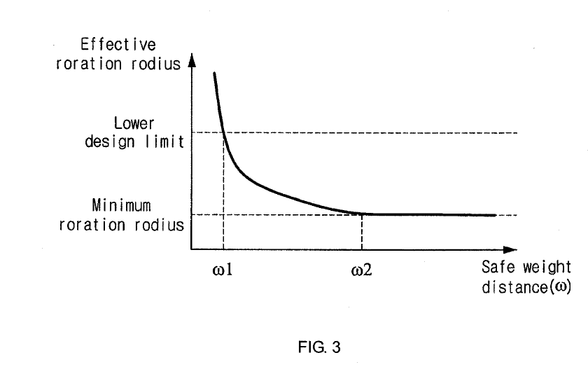

FIG. 2 is a graph showing a relationship between a safe weight distance and an acceptable climbing angle, and FIG. 3 is a graph showing a relationship between the safe weight distance and an effective rotation radius.

The tractor according to the embodiment is designed on the basis of a safe weight distance ω and an effective hydraulic efficiency area μ which are introduced to determine an optimal lift range of the hydraulic lifting apparatus.

The applicant has introduced the concept of the safe weight distance ω which is an index representing safety considering weight of a vehicle and lift of a hydraulic lifting apparatus. Assuming that the lift of the hydraulic lifting apparatus is P (N), an axial distance between a front wheel and a rear wheel of the tractor is L (m), and the total weight of the tractor is W (N), the safe weight distance ω is defined by Equation (1).

ω=L×W/P (1)

The safe weight distance ω defined as above has an influence on an acceptable climbing angle and an effective rotation radius of the tractor.

The acceptable climbing angle represents a maximum climbing angle so as not to cause the vehicle to overturn when climbing up a hill such as the ridge of a rice field. As illustrated in FIG. 2, as the safe weight distance ω is increased, the acceptable climbing angle of the tractor is increased and a possibility that the tractor overturns is reduced, so that safety is ensured. Therefore, in consideration of the acceptable climbing angle, a minimum value ω1 of the safe weight distance ω needs to be set.

The effective rotation radius represents a minimum rotation radius to rotate under the same condition. As illustrated in FIG. 3, when the safe weight distance ω is reduced to be smaller than a predetermined value, contact force of the front wheel is reduced, and slippage between a tire and ground may occur, resulting in an increase in the effective rotation radius. This degrades running safety and operability of the tractor and may cause operation failure during running at high speed. In addition, when the safe weight distance ω is further reduced, the contact force becomes 0 and the effective rotation radius becomes infinite, resulting in a steering failure state. Therefore, in consideration of the effective rotation radius, the minimum value ω1 of the safe weight distance ω needs to be set.

In consideration of the acceptable climbing angle and the effective rotation radius of the tractor, the safe weight distance ω of the tractor has to be designed to be greater than 1.5 m as in Equation (2).

ω>1.5 m (2)

Meanwhile, when the safe weight distance ω becomes equal to or greater than a predetermined value ω2, the acceptable climbing angle of the tractor is not increased any more and has a predetermined value (see FIG. 2), and the effective rotation radius is not reduced any more (see FIG. 3). Therefore, the safe weight distance ω may be designed so as not to be greater than the predetermined upper limit ω2.

The upper limit ω2 is determined depending on a normal force of the front wheel which has an influence on the effective rotation radius. Assuming that the normal force of the front wheel is F_{N}(N), and a load of the front wheel is W_{F}(N), the following relationships are established.

F_{N}=W_{F}−P/L (3)

W_{F}=0.5W (4)

In addition, the normal force F_{N}(N) of the front wheel has a value equal to or smaller than 30% of the total weight W(N) of the tractor as in Equation (5).

F_{N}≦0.3W (5)

When Equations (3) and (4) are substituted in Equation (5), Equation (9) is finally derived through Equations (6) to (8).

0.5W−P/L≦0.3W (6)

0.2W≦P/L (7)

L×W/P≦5 (8)

ω≦5 m (9)

Therefore, the upper limit ω2 of the safe weight distance ω should be equal to or smaller than 5 m.

An output of an engine of the tractor is used for running or for other apparatuses such as a power take-off (PTO), a hydraulic apparatus or an air conditioner. Particularly, the hydraulic apparatus converts the output of the engine into a hydraulic form using a hydraulic pump so as to be used for hydraulic lifting or power steering. Given the same engine and the same PTO output, the greater the output of the hydraulic pump and the lift of the hydraulic lifting apparatus, the higher is the efficiency.

The applicant has introduced the concept of the effective hydraulic efficiency area μ which is an index representing the efficiency of the hydraulic lifting apparatus of the tractor. Assuming that the lift of the hydraulic lifting apparatus is P (N), a discharge flow rate of the hydraulic pump is Q (m³/s), and the horsepower of the engine is H (N·m/s), the effective hydraulic efficiency area μ is defined by Equation (10).

μ=P×Q/H (10)

As the effective hydraulic efficiency area μ is increased, higher force is exhibited for the same power, which means that the tractor operates at higher efficiency. In other words, when the effective hydraulic efficiency area μ is reduced than a predetermined value, kinds of operating machine that can be mounted are reduced for the same output of the engine, and the output of the operating machine is also reduced. Therefore, in consideration of the efficiency of the tractor, the effective hydraulic efficiency area μ has to be equal to or greater than 100 m² as in Equation (11).

μ>100 m² (11)

Meanwhile, when the effective hydraulic efficiency area μ becomes greater than a predetermined value, this acts as a load on parts other than the hydraulic apparatus. That is, power needed for running becomes insufficient, and hauling power, climbing ability, running ability, and the like are reduced. In the case of PTO, operation efficiency may be reduced during a rotary operation. Therefore, the effective hydraulic efficiency area μ may be suitably designed so as not to exceed a predetermined upper limit Y.

The range of the lift P of the hydraulic lifting apparatus is obtained from the range of the safe weight distance ω and the range of the effective hydraulic efficiency area μ described above.

Combing Equations (1) and (2) gives Equation (12).

P<L×W/1.5 (12)

In addition, Equation (13) is obtained from Equations (10) and (11).

100×H/Q<P (13)

Equation (12) describes the upper limit of the lift P, and Equation (13) describes the lower limit of the lift P. Therefore, by combining Equations (12) and (13), the range of the lift is finally obtained as Equation (14).

100×H/Q<P<L×W/1.5 (14)

Thus, the hydraulic lifting apparatus satisfying Equation (14) is an apparatus that satisfies both the safety and efficiency of the tractor.

While the exemplary embodiments have been shown and described, it will be understood by those skilled in the art that various changes in form and details may be made thereto without departing from the spirit and scope of this disclosure as defined by the appended claims.

In addition, many modifications can be made to adapt a particular situation or material to the teachings of this disclosure without departing from the essential scope thereof. Therefore, it is intended that this disclosure not be limited to the particular exemplary embodiments disclosed as the best mode contemplated for carrying out this disclosure, but that this disclosure will include all embodiments falling within the scope of the appended claims.

1. A tractor having a hydraulic lifting apparatus,
wherein, assuming that a lift of the hydraulic lifting apparatus is P (N), a discharge flow rate of a hydraulic pump is Q (m³/s), a horsepower of an engine is H (N·m/s), an axial distance is L (m), and a total weight of the tractor is W (N), the following equation is satisfied:
100×H/Q<P<L×W/1.5.

2. The tractor according to claim 1,
wherein a value obtained by dividing a value obtained by multiplying the axial distance L and the total weight W by the lift P is defined as a safe weight distance ω, and
the safe weight distance ω is equal to or greater than 1.5 m and equal to or smaller than 5 m.

3. The tractor according to claim 1,
wherein a value obtained by dividing a value obtained by multiplying the discharge flow rate Q and the lift P by the horsepower H is defined as an effective hydraulic efficiency area μ, and
the effective hydraulic efficiency area μ is equal to or greater than 100 m².

4. The tractor according to claim 2,
wherein a value obtained by dividing a value obtained by multiplying the discharge flow rate Q and the lift P by the horsepower H is defined as an effective hydraulic efficiency area μ, and
the effective hydraulic efficiency area μ is equal to or greater than 100 m².
